(19) United States
(12) Patent Application Publication
(10) Pub. No.: US 2024/0102375 A1
(43) Pub. Date: Mar. 28, 2024

(54) CIVIL ENGINEERING MACHINE AND METHOD FOR CREATING A FOUNDATION IN THE GROUND

(71) Applicant: BAUER Maschinen GmbH, Schrobenhausen (DE)

(72) Inventors: Peter BRÜDERLE, Karlskorn (DE); Andreas SCHOBER, Wertingen (DE)

(73) Assignee: BAUER Maschinen GmbH, Schrobenhausen (DE)

(21) Appl. No.: 18/472,379

(22) Filed: Sep. 22, 2023

(30) Foreign Application Priority Data
Sep. 23, 2022 (EP) 22 197 380.3
Aug. 1, 2023 (EP) 23 189 020.3

(51) Int. Cl. E21B 44/00; E21B 7/02; E21B 41/00; E21B 45/00

(52) U.S. Cl. CPC E21B 44/00; E21B 7/022; E21B 41/00; E21B 45/00

(57) ABSTRACT

The invention relates to a civil engineering machine for producing a foundation in the ground, which is configured to create a hole in the ground to a specified target depth for forming at least one foundation element in the ground or to introduce at least one foundation element directly into the ground to the specified target depth, comprising a control unit, into which the target depth can be input, and a display device, in particular a screen, on which data on the operation of the civil engineering machine can be displayed by the control unit. According to the invention, it is provided that the control unit is configured to calculate, based on the input target depth and depending on parameters that can be or are input to the control unit for producing of the foundation, an expected target reaching time until the input target depth is reached and to display it by means of the display device.

The invention relates to a civil engineering machine for creating a foundation in the ground, which is configured to produce a hole in the ground to a specified target depth for creating at least one foundation element in the ground or to introduce at least one foundation element directly into the ground to a specified target depth, having a control unit, into which, in particular, the target depth can be input, and a display device, in particular a screen, on which data on the operation of the civil engineering machine can be displayed by the control device, according to the preamble of claim 1.

The invention further relates to a method for creating a foundation in the ground, in which a hole is produced in the ground to a specified target depth for forming at least one foundation element in the ground, or at least one foundation element is introduced directly into the ground to the specified target depth, wherein in particular the target depth is input into a control unit of the civil engineering machine, and wherein data on the operation of the civil engineering machine are displayed by the control unit on a display device, in particular a screen, of the civil engineering machine, according to the preamble of claim 15.

Civil engineering machines and methods for creating foundations in the ground have been known for a long time. A foundation element can be formed, for example, by creating a hole in the ground, such as a drilled hole or a cutting trench, with the hole then being filled with a curable medium, in particular a cement, to form then a foundation pile or a diaphragm wall segment with an additional reinforcement, as the case may be. A foundation element may also be formed by driving or vibrating in, for example, a foundation pile or a screed. A foundation element in the sense of the present invention is not limited to a load-bearing function or a load-bearing capacity function but can alternatively or additionally also assume a sealing function and/or other tasks, as is known, for example, in the case of construction pit enclosures with diaphragm walls from special civil engineering.

Nowadays, well-known civil engineering machines are equipped with electronic control units that can facilitate the operation of the civil engineering machine for a machine operator or even take it over partially or fully automatically. Various operating data can be recorded via sensors and fed to the control unit. Control commands can be issued to corresponding actuators, in particular drives and actuating cylinders, via corresponding data lines.

Such civil engineering machines are known, for example, from EP 3299523 A1, EP 3296467 A1.

For an efficient workflow on a construction site, the timely creation of a foundation is of decisive importance, since a foundation must be created at the beginning of a construction project. Time delays in the foundation can lead to temporal delays in the subsequent subsections.

The object underlying the invention is to specify a civil engineering machine and a method with which a foundation in the ground can be created particularly efficiently and according to plan.

The object is achieved on the one hand by a civil engineering machine having the features of claim 1 and on the other hand by a method having the features of claim 15. Preferred embodiments of the invention are indicated in the dependent claims.

The civil engineering machine according to the invention is characterized in that a calculation device is provided, in particular as a part of the control unit and is configured to calculate an expected target reaching time until the input target depth is reached, based on the input target depth and depending on input parameters for producing the foundation, and to display it with the display device. Preferably, the parameters are input or can be input in the control unit.

A basic idea of the invention is to display to a machine operator and/or another person or several other persons, for example a foreman or a site manager, based on the input target depth of the foundation element to be created, preferably by the control unit, the expected target reaching time on a display device. The target reaching time can be calculated by the calculation device, preferably the control unit, depending on stored parameters. In the simplest case, an average advance speed for the civil engineering machine used and/or the tool used can be stored as a parameter. The calculated target reaching time can be calculated once at the beginning or several times during working and, if necessary, updated and specified. The target reaching time can include the time until the target depth is reached and, if necessary, additional time information for completing the foundation measure.

For example, specifying the target reaching time makes it easier for a machine operator to operate the civil engineering machine and for other persons to plan the construction site. It allows a better estimate of whether and, if so, how many foundation elements can be completed by the end of a shift. The determination of a target reaching time also allows coordination with further operating measures, such as the supply of reinforcement cages, of curable media, in particular mortar or cement slurry, and/or the delivery of further construction materials and/or foundation elements for subsequent work.

According to a further development of the invention, a particularly accurate calculation of the expected target reaching time is achieved in that the parameters comprise values concerning one or more of the following indications: Ground type, ground profile, working method, working tool, machine type, drive power, rotational speed and/or torque of the drive, rotational speed of the working tool, feed force and/or feed rate: The corresponding values of the parameters can be input or queried in advance by the machine operator and/or a main office or recorded and stored by the machine itself before or during operation.

The information on the ground type can include, in particular, information on the strength of the ground and thus the expected advancing speed. In the case of an input ground profile, it can be taken into account that the ground can be built up in layers from ground layers of different strength. A basic work sequence can be stored for the working method, for example whether continuous drilling with an endless auger or discontinuous drilling with a drilling bucket is planned. Data on the dimensioning and/or the condition, in particular an actual or expected state of wear, of the working tool can also have an influence on the advance speed. The same applies to various performance data of the machine with regard to the rotational speed and/or torque of the drive, the rotational speed of the working tool, the feed force and/or a feed rate or a feed speed. When determining the target reaching time, other parameters can also be taken into account, which can have an influence on the working speed when creating the foundation element. Parameters can also concern a measured or calculated tool wear. For example, it can be taken into account if the tool or the tool set has to be changed, which can also be included in the calculation of the target reaching time.

According to an advantageous embodiment of the invention, it is convenient that the calculation device is arranged integrated into the control unit of the civil engineering machine or is arranged separately therefrom, wherein the calculation device is in communication with the control unit via a data transmission device. The calculation device may be an integral part of the control unit of the civil engineering machine. However, the calculation device may also be partially or entirely formed separately therefrom, for example on a mobile computer, such as a laptop or a tablet computer, or at a remote location, such as a site manager's office or a central office, with a connection exist via a preferably wireless data connection or via the Internet.

According to a further development of the invention, it is preferred that the control unit or the calculation unit is configured to automatically detect parameters by means of one or more sensor devices and/or to query them from a machine-internal and/or external database. In particular, the control unit can detect and determine a working speed until a first depth is reached which is smaller than the target depth. On the basis of this first working step for a first distance, a projection can be carried out by the control unit until the target depth is reached.

At a construction site, a working speed for a previously created foundation element can also be used to calculate the subsequent target reaching time. Corresponding data can also be retrieved from a main office, in particular if several identical or similar civil engineering machines are used at larger construction sites. Data and information on the geology of the ground can also be recorded by the machine itself or retrieved from an external database, in which data from a soil expertise usually prepared for construction sites is stored, for example. The more and the more concrete the recorded or stored data on the parameters are, the more precisely the target reaching time can be predicted.

In principle, the target reaching time can be determined once at the start of processing. For a particularly precise determination of the target reaching time, it is advantageous according to one embodiment of the invention that the control unit is configured to adapt the parameters to changing conditions during the production of the foundation and to calculate the expected target reaching time on an up-to-date basis and display it by means of the display device. The target reaching time can be continuously redetermined. Preferably, the recalculation is performed at predetermined time intervals, which can be in the range of seconds or minutes, for example.

According to a further development of the invention, it is particularly informative, for example for an operator, that the expected target reaching time can be indicated by displaying a time duration and/or a time of day when the target is reached. This makes it possible, in particular, to coordinate with further measures that are to be initiated and/or prepared in the course of producing of the foundation element or when the target depth is reached, or to schedule necessary work breaks. In addition to a time indication, it can also be useful to indicate the current working depth and/or a remaining depth still to be worked until the target depth is reached.

A further preferred embodiment of the invention is that a data transmission device is arranged with which parameters can be transmitted from an external database or a main office to the control unit and/or from the control unit to the external database or the main office. In principle, the target depth and/or the parameters can be input manually by a machine operator via an input device, such as a keyboard. However, data input can also be carried out in any other suitable manner, for example from a data carrier or by data transmission from an internal or external data storage device by cable or wirelessly. The data transmission device can be operated accordingly for data transmission wired and/or wirelessly.

According to a further embodiment variant of the invention, it is advantageous that the control unit or the calculation unit is configured to display further time indications for measures to be carried out or recommended on the display device depending on the expected target reaching time. In this way, the control unit can indicate times or clock times at which, for example, a further material order, for example of mortar or cement suspension, of reinforcement cages and/or further foundation piles or planks are indicated. In particular, it may be preferred that the control unit triggers the corresponding measures automatically and/or after release by the machine operator, in particular via a main office. This can make the workflow at the construction site even more efficient.

The target reaching time can be sent to a remote main office, in particular a site management or site main office, for monitoring and controlling the construction process.

According to a further development of the invention, a further improvement of the operating process can be achieved by the control unit being configured such that the measures displayed on the display device can be confirmed and triggered directly by the machine operator. In this context, the display device can be configured, in particular as a touch screen or a screen with a cursor or mouse control, the displayed actions on the display device being configured as active control fields. These can be initiated or triggered by simple touch in the case of a touchscreen or by clicking with a cursor.

A further preferred embodiment of the invention is that the control unit or the calculation unit is configured to identify an actual time of production when the target depth is reached and to compare it with the calculated expected target reaching time and to take into account a comparison result when calculating an expected target reaching time when producing a subsequent foundation. By comparing the actual time actually achieved and the target reaching time calculated in advance as a target time, a further improvement in the accuracy for determining the target reaching time can be achieved.

Preferably, an analysis of the causes of deviations that have occurred between the actual time and the target time can also be determined by a corresponding computer program with artificial intelligence and thus further taken into account in subsequent determinations of target reaching times.

In principle, the civil engineering machine can be configured in any known manner, which can be used for creating a foundation in the ground. According to one embodiment of the invention, it is preferred that the civil engineering machine further comprises: a mobile carrier device, a mast or a boom arm, which is arranged on the carrier device, and a civil engineering tool, which is adjustably arranged on the mast or the boom arm, respectively, for carrying out a civil engineering measure for producing the foundation, in particular for reaching the target depth.

The mobile carrier device can, in particular have a crawler chassis or a wheeled chassis. The mast, which may, in particular be arranged substantially vertically in operation, may be configured as a simple mast, a leader mast or a telescopic leader. A boom arm may, in particular be pivotally arranged about a horizontal pivot axis on the carrier device. A carrier device may, in particular comprise an upper carriage rotatably mounted on an undercarriage about a vertical axis of rotation. In particular, a drilling tool, a mixing tool, a diaphragm wall grab or cutting wheels can be provided as a civil engineering tool. In principle, a screed or a pile can also be provided as a civil engineering tool if these can be introduced directly into the ground with displacement of ground material. A pile can be configured, in particular as a driven or vibrated pile with a corresponding pile tip. The foundation element to be introduced can also be configured as a pile or support tube.

The civil engineering machine according to the invention can preferably be configured as a drilling rig, a trench cutter, a grab excavator, a pile driver or a vibrator. A drilling rig and a trench cutter can first be used to create a hole in the ground, in which the foundation element is then arranged or formed. In particular, a hole in the ground formed by drilling, grabbing or cutting, i.e. preferably by removal, may be filled with a curable suspension and optionally with one or more reinforcing elements, wherein the suspension then cures to form the foundation element. The curable suspension may be produced outside the hole and introduced into it, or it may be produced in situ in the hole with removed ground material remaining in the hole, or in other words with dissolved ground material as a so-called ground mortar. By means of a pile driver or vibrator, an existing foundation element, in particular a pile or screed, can be driven directly into the ground, in particular under ground displacement, to form the foundation element.

The method according to the invention is characterized in that, based on an input target depth, the control unit calculates an expected target reaching time depending on parameters that can be input or are input into the control unit for producing the foundation and is displayed with the display device.

In principle, any suitable display device can be used. According to one embodiment of the invention, it is particularly preferred that the display device comprises at least one screen, data glasses, VR or AR glasses, a tablet, a smartphone, a head-up display and/or an in-glass display.

Advantageously, according to a further development according to the invention, the control unit or the calculation unit is configured to forward or transmit the calculated target reaching time to a main office or a remote device. Thus, this information can be sent to any location for which this information is useful.

The method according to the invention can be carried out in particular by means of an above described civil engineering machine according to the invention. The advantages described above can be achieved.

The invention is further described below with reference to preferred exemplary embodiments, which are shown schematically in the drawings. The drawings show in:

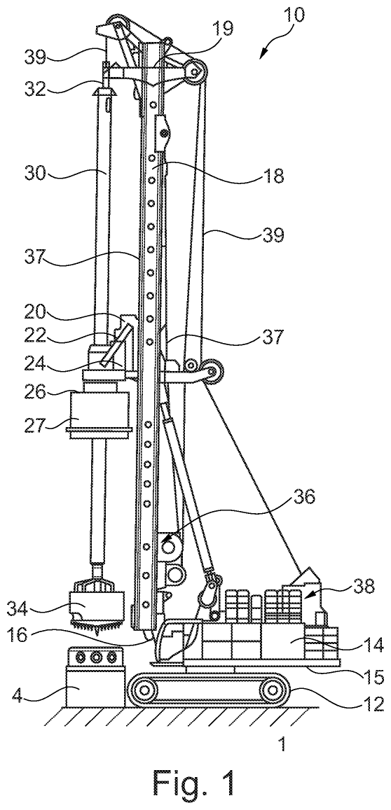

FIG. 1 a schematic side view of a civil engineering machine according to the invention, and

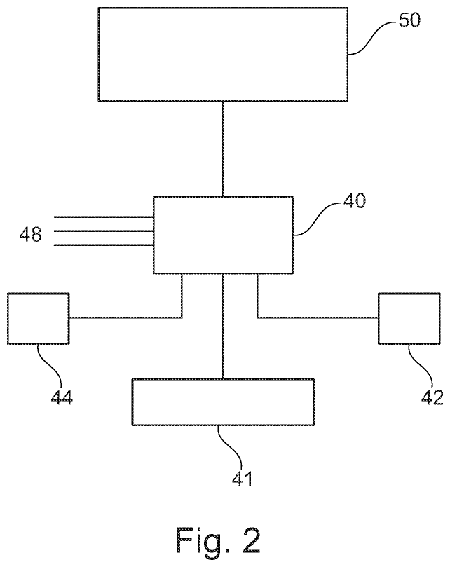

FIG. 2 a schematic illustration of the control unit with display device.

A civil engineering machine 10 according to the invention, which is exemplarily configured as a drilling rig according to FIG. 1, has an undercarriage 12 preferably configured as a crawler chassis and an upper carriage 14 rotatably mounted thereon. The undercarriage 12 and the upper carriage 14 form a carrier device 15. The drive units and the control station for a machine operator of the civil engineering machine 10 can be arranged on the upper carriage 14 in a known manner. A control unit and a display device, in particular a screen, can be arranged in the operator's cab.

A substantially vertical mast 18 with an upper mast head 19 can be adjustably attached to a front side of the upper carriage 14 via an articulated kinematic system 16 with neck cylinders. A slide 20 may be slidably guided along a front side of the mast 18. A first auger drive 22 may be provided on the slide 20, which may include a hydraulic motor 24. Further, a second drive 26 having a sleeve-shaped rotary connection 27 may be provided on the slide 20 for establishing a torque proof connection to a support tube 4. The second drive 26 may, for example, substantially consist of a transmission connection to the first auger drive 22 with the hydraulic motor 24, so as to apply torque to the rotary connection 27 and thus the support tube 4.

The approximately sleeve-shaped first auger drive 22 may, by way of example, be penetrated by a drill string 30, which may be configured as a Kelly linkage having outer drive bars. Here, the drill string 30 may include an upper suspension 32 by which the drill string 30 is connected to a main cable 39. The main cable 39 may be guided by pulleys at the mast head 19 to a main winch 38 at the top of the upper carriage 14. By operating the main winch 38, the drill string 30 can be moved vertically.

The slide 20 may be connected to a feed cable 37, which may be guided along the mast 18 above and below the slide 20 and actuated by a feed winch 36. The feed winch 36 can move the slide 20 upwards or downwards along a guide of the mast 18.

A drilling tool is attached to an underside of the drill string 30 as a civil engineering tool 34 for removing ground material. The civil engineering tool 34 is configured as a drilling bucket in the illustrated exemplary embodiment according to FIG. 1. The diameter of the drilling tool is configured in such a way that it can be inserted into the inner cavity of the support tube 4.

The civil engineering machine 10 can be used to create a lined bore in the ground 1. To form a foundation element in the ground 1, a curable mass can be introduced into the bore, which then cures to form the foundation element. The support tube 4 may remain in the bore as part of the foundation element or, preferably, may be withdrawn from the ground 1 prior to curing.

FIG. 2 shows the arrangement of a control unit 40 for a civil engineering machine 10 according to the invention, wherein the control unit 40 is connected to a display device 50 by cable or wirelessly. The display device 50 can, in particular be configured as a screen with which data on the operation of the civil engineering machine 10 can be displayed in the operator's cab of the civil engineering machine 10.

Via an input device 41, which, merely by way of example, can be configured as a keyboard, a target depth can be input into the control unit 40 during the creation of a foundation in the ground 1. Based on the input target depth and depending on parameters for producing the foundation, a target reaching time until an input target depth is reached can be calculated by the control unit 40 and displayed to a machine operator on the display device 50. The control unit 40 can take into account parameters that can be input into the control unit 40 via various paths and/or sources in order to determine the target reaching time.

The parameters may be supplied to the control unit 40 via the input device 41 from an internal machine data store 42, from an external machine data store 44, a central station, and/or directly from various sensor devices 48 on the civil engineering machine 10 to calculate the target reaching time. The target reaching time can be displayed to a machine operator via the display device 50, so that the machine operator can use this information for efficient operation of the civil engineering machine 10.

1. A civil engineering machine for creating a foundation in the ground, which is configured to create a hole in the ground to a specified target depth for forming at least one foundation element in the ground or to introduce at least one foundation element directly into the ground to the specified target depth, comprising
a control unit, and
a display device, in particular a screen, on which data on the operation of the civil engineering machine can be displayed by the control unit,
wherein
a calculation device is provided and configured to calculate, based on the input target depth and depending on input parameters for producing the foundation, an expected target reaching time until the input target depth is reached and to display it with the display device.

2. The civil engineering machine according to claim 1,
wherein
the parameters include values concerning one or more of the following indications:
Ground type, ground profile, working method, civil engineering tool, machine type, drive power, rotational speed of the drive, rotational speed of the civil engineering tool, feed force and/or feed rate.

3. The civil engineering machine according to claim 1,
wherein
the calculation device is arranged integrated into the control unit of the civil engineering machine or is arranged separately therefrom, wherein the calculation device is in communication with the control unit via a data transmission device.

4. The civil engineering machine according to claim 1,
wherein
the control unit or the calculation device is configured to automatically record parameters by means of one or more sensor devices and/or to retrieve them from a machine-internal and/or external data storage.

5. The civil engineering machine according to claim 1,
wherein
the control unit or the calculation device is configured to adapt the parameters to changing conditions during the production of the foundation and to calculate the expected target reaching time on an up-to-date basis and to display it by means of the display device.

6. The civil engineering machine according to claim 1,
wherein
the expected target reaching time can be indicated by displaying a time duration and/or a time of date when the target is reached.

7. The civil engineering machine according to claim 1,
wherein
a data transmission device is arranged, with which parameters can be transmitted from an external data storage or a main office to the control unit and/or from the control unit to the external data storage or the main office.

8. The civil engineering machine according to claim 1,
wherein
the control unit or the calculation device is configured to display further time indications for measures to be carried out or recommended measures on the display device depending on the expected target reaching time.

9. The civil engineering machine according to claim 7,
wherein
the control unit or the calculation device is configured that the measures displayed on the display device can be confirmed and triggered directly by an operator.

10. The civil engineering machine according to claim 1,
wherein
the control unit or the calculation device is configured to identify an actual time of production when the target depth is reached and to compare it with the calculated expected target reaching time and to take into account a comparison result when calculating an expected target reaching time when producing a subsequent foundation.

11. The civil engineering machine according to claim 1,
wherein
the civil engineering machine further comprises:
a mobile carrier device,
a mast or a boom arm which is arranged on the carrier device, and
a civil engineering tool, which is adjustably arranged on the mast or the boom arm for carrying out a civil engineering measure for producing the foundation, in particular for reaching the target depth.

12. The civil engineering machine according to claim 1,
wherein
the civil engineering machine is configured as a drilling rig, a trench cutter, a grab excavator, a pile driver or a vibrator.

13. The civil engineering machine according to claim 1,
wherein
the display device comprises at least one screen, data glasses, VR or AR glasses, a tablet, a smartphone, a head-up display, and/or an in-glass display.

14. The civil engineering machine according to claim 1,
wherein
the control unit or the calculation device is configured to forward or transmit the calculated target reaching time to a main office or a remote device.

15. A method for producing a foundation in the ground, in particular with a civil engineering machine according to claim 1, in which
a hole is created in the ground to a specified target depth for forming at least one foundation element in the ground, or at least one foundation element is introduced directly into the ground to the specified target depth, and
data for operating the civil engineering machine is displayed on a display device, in particular a screen, of the civil engineering machine by a control unit,
wherein
based on the specified target depth, an expected target reaching time is calculated by a calculation device depending on input parameters for producing the foundation and is displayed to a machine operator by means of the display device.
